(19) United States
(12) Patent Application Publication
(10) Pub. No.: US 2024/0017273 A1
(43) Pub. Date: Jan. 18, 2024

(54) A CENTRIFUGAL SEPARATOR AND A METHOD OF OPERATING A CENTRIFUGAL SEPARATOR

(71) Applicant: Alfa Laval Corporate AB, LUND (SE)

(72) Inventor: Jouko PITKÄMÄKI, ESKILSTUNA (SE)

(73) Assignee: Alfa Laval Corporate AB, LUND (SE)

(21) Appl. No.: 18/037,177

(22) PCT Filed: Nov. 17, 2021
(86) PCT No.: PCT/EP2021/081957

§ 371 Date: May 16, 2023

(30) Foreign Application Priority Data
Dec. 7, 2020 (EP) 20212159.6

(51) Int. Cl. B04B 1/14; B04B 1/08

(52) U.S. Cl. CPC B04B 1/14; B04B 1/08

(57) ABSTRACT

A centrifugal separator for separating a liquid heavy phase and light phase from a liquid feed mixture includes a drive member and a rotating part. The rotating part includes a centrifuge rotor enclosing a separation space and a sludge space. The centrifugal separator includes an inlet for receiving the liquid feed mixture into the centrifuge rotor, a first outlet for the liquid heavy phase and a second outlet for the liquid light phase. The centrifugal separator includes a conduit system for recirculating separated liquid heavy phase discharged from a first outlet to the sludge space within the centrifuge rotor without mixing the recirculated separated liquid heavy phase with the liquid feed mixture. Sludge outlets, other than the first and second outlets, discharge sludge separated from said liquid feed mixture. A method for separating a liquid heavy phase and a liquid light phase from a liquid feed mixture is also disclosed.

### FIELD OF THE INVENTION

The present invention relates to the field of centrifugal separators, and more particularly to a method of operating a centrifugal separator, such as a centrifugal separator for cleaning marine fuel oil.

### BACKGROUND OF THE INVENTION

Centrifugal separators are generally used for separation of liquids and/or for separation of solids from a liquid. During operation, liquid mixture to be separated is introduced into a rotating bowl and heavy particles or denser liquid, usually water, accumulates at the periphery of the rotating bowl whereas less dense liquid accumulates closer to the central axis of rotation. This allows for collection of the separated fractions, e.g. by means of different outlets arranged at the periphery and close to the rotational axis, respectively.

Fuels supplied to ships is usually treated on board before use in the engine in order to remove solid contaminants, such as particles of silicon and aluminium compounds (e.g. microporous aluminium silicates or aluminosilicates known as zeolites), called catalyst fines, and liquid contaminants such as water. Marine diesel engines usually accept several types of commercially available fuel oils as long as they are adequately treated on board the ship. Further, also lubricating oils for an engine may contain a portion of solid and liquid impurities, such as water, that need to be separated before use

Heavy phase recirculation is a well-known technique in oil separation, in which separated heavy phase, such as water, is fed back to the inlet. This is to decrease the amount of liquid light phase, i.e. oil, that is separated out with the heavy phase, i.e. the water.

Thus, water may be recirculated to the inlet of the centrifugal separator, and this course will go on either during a certain predetermined time or until a certain amount of separated water has collected within the separation chamber. When the predetermined time has lapsed, so called sludge outlets may be opened so that separated solids together with water accumulated within the centrifuge rotor will be thrown out of the separation chamber.

However, there is still a need in the art for improved separation of oils, such as separation of water from fuel oils or lubricating oils.

### SUMMARY OF THE INVENTION

It is an object of the invention to at least partly overcome one or more limitations of the prior art. In particular, it is an object to provide a method and a centrifugal separator having increased capabilities of separating oils from e.g. water and dirt.

As a first aspect of the invention, there is provided a centrifugal separator for separating a liquid heavy phase and a liquid light phase from a liquid feed mixture, comprising
a frame, a drive member and a rotating part,
wherein the drive member is configured to rotate the rotating part in relation to the frame around an axis of rotation (X), and
wherein the rotating part comprises a centrifuge rotor enclosing a separation space and a sludge space;
wherein the separation space comprises a stack of separation discs arranged coaxially around the axis of rotation (X) and wherein the sludge space is arranged radially outside the stack of separation discs;
wherein the centrifugal separator further comprises an inlet for receiving the liquid feed mixture into the centrifuge rotor, a first outlet for the liquid heavy phase and a second outlet or the liquid light phase, and
wherein the centrifugal separator further comprises a conduit system for recirculating separated liquid heavy phase discharged from the first outlet to the sludge space within the centrifuge rotor of the centrifugal separator without mixing the recirculated separated liquid heavy phase with the liquid feed mixture. The centrifugal separator further comprises sludge outlets, other than the first and second outlets, for discharge of sludge separated from said liquid feed mixture.

The centrifugal separator is for separation of a liquid feed mixture. The liquid feed mixture may be an aqueous liquid or an oily liquid. As an example, the centrifugal separator may be for separating impurities, such as water and/or particles, from oil, such as fuel oil or lubricating oil. The liquid feed mixture is thus separated into at least two phases; a liquid light phase and a liquid heavy phase. The liquid heavy phase has a density that is higher than the density of the light phase. The centrifugal separator may be arranged to separate the liquid feed mixture into a liquid light phase, a liquid heavy phase and a solids phase, i.e. a sludge phase.

The separated liquid heavy phase may comprise more than 50% wt of liquid, such as more than 75% wt of liquid, such as more than 90% wt of liquid. In analogy, a sludge phase may comprise a small amount of liquid, but such as at least 50% wt of solids, such as more than 75% wt of solids.

The frame of the centrifugal separator is a non-rotating part, and the rotating part may be supported by the frame by at least one bearing device, which may comprise a ball bearing. The rotating part of the separator may be arranged to be rotated around vertical axis of rotation, i.e. the axis of rotation (X) may extend vertically. The rotating part comprises a centrifuge rotor. The centrifuge rotor is usually supported by a spindle, i.e. a rotating shaft, and may thus be mounted to rotate with the spindle. Consequently, the rotating part may comprise a spindle that is rotatable around the axis of rotation (X). The centrifugal separator may be arranged such that the centrifuge rotor is supported by the spindle at one of its ends, such at the bottom end or the top end of the spindle.

The drive member for rotating the rotating part of the separator may comprise an electrical motor having a rotor and a stator. The rotor may be fixedly connected to the rotating part, such as to a spindle. Advantageously, the rotor of the electrical motor may be provided on or fixed to the spindle of the rotating part. Alternatively, the drive member may be provided beside the spindle and rotate the rotating part by a suitable transmission, such as a belt or a gear transmission.

The centrifuge rotor encloses by rotor walls a separation space and a sludge space. The separation space, in which the separation of the fluid mixture takes place, comprises a stack of separation discs. The separation discs may e.g. be of metal. Further, the separation discs may be frustoconical separation discs, i.e. having separation surfaces forming frustoconical portions of the separation discs. The angle of inclination of the separation surface may be within the range of 30-50 degrees, preferably about 40 degrees, to the radial direction. Radially outside of the stack of separation discs is the sludge space, in which separated sludge and heavy phase is collected during operation. The sludge space thus extends radially from the outer portion of the stack of separation discs to the inner periphery of the centrifuge rotor.

The separation discs are arranged coaxially around the axis of rotation (X) at a distance from each other such that to form passages between each two adjacent separation discs. The separation discs in the disc package may be arranged such that the liquid mixture to be separated flows radially inwards in the passages between each two adjacent separation discs of the stack.

As used herein, the term “axially” denotes a direction which is parallel to the rotational axis (X). Accordingly, relative terms such as “above”, “upper”, “top”, “below”, “lower”, and “bottom” refer to relative positions along the rotational axis (X). Correspondingly, the term “radially” denotes a direction extending radially from the rotational axis (X). A “radially inner position” thus refers to a position closer to the rotational axis (X) compared to “a radially outer position”.

The centrifugal separator may be arranged such that a separated heavy liquid phase move towards the periphery of the separator space and is then guided above the disc stack to the first outlet.

The centrifugal separator also comprises an inlet for liquid mixture to be separated (the liquid feed mixture). This inlet may be arranged for receiving the liquid feed mixture and be arranged centrally in the centrifuge rotor, thus at rotational axis (X).

The first and second outlets are liquid outlets. The second liquid outlet for the liquid light phase may be arranged at a smaller radius than the first liquid outlet.

The centrifugal separator further comprises sludge outlets, other than the first and second outlets, for discharge of sludge separated from said liquid feed mixture. Thus, the separator may further comprise a third set of outlets for discharging sludge and liquid heavy phase accumulated in the sludge space. For this purpose, the centrifuge rotor may for example comprise at its outer periphery a set of radially sludge outlets in the form of intermittently openable outlets. The centrifuge rotor may as an alternative comprise at its outer periphery open nozzles through which certain flow of sludge and/or heavy phase is discharged continuously.

Consequently, the centrifugal separator may comprise a first liquid outlet for a heavy phase, a second liquid outlet for a light phase and sludge outlets for separated sludge.

In embodiments, the sludge outlets are arranged for intermittent discharge of sludge separated from the liquid feed mixture. Thus, in such embodiments, the centrifuge bowl may be free of any outlets for continuous discharge of a separated sludge phase.

The first and/or the second outlets may be arranged on an upper portion of the centrifuge rotor, such as axially above the stack of separation discs.

The first and second liquid outlets may be arranged in a first and second outlet chamber, respectively. These chambers may comprise a stationary paring device for discharging a separated liquid phase. Thus, the first liquid outlet may be in the form of a first stationary paring device arranged in a first outlet chamber, whereas the second liquid outlet may be in the form of a second stationary paring device arranged in a second outlet chamber.

Thus, during operation, a separated liquid phase may form a liquid body rotating with the rotating part in an outlet chamber, and a stationary paring device arranged in the outlet chamber may be arranged for paring the liquid phase out of the centrifugal separator. The stationary paring device may be a paring disc, such as an annular paring disc.

The centrifugal separator further comprises a conduit system for recirculating separated liquid heavy phase to the sludge space within the centrifuge rotor of the centrifugal separator without mixing the recirculated separated liquid heavy phase with the liquid feed mixture. The conduit system may comprise pipes or channels, both within and outside of the centrifuge rotor.

The term “without mixing the recirculated separated liquid heavy phase with the liquid feed mixture” thus relates to recirculating the separated liquid heavy phase without mixing it with the liquid feed before it is supplied to a position within or at the radial inner portion of the sludge space. Thus, the recirculated heavy phase is not mixed with the liquid feed mixture upstream of the sludge space, such as at the inlet of the centrifugal separator. However, the recirculated liquid heavy phase may be mixed with the liquid feed mixture within the volume of the sludge space once it has been supplied to the sludge space.

The first aspect of the invention is based on the insight that recirculated heavy phase may form phases that are difficult to separate when being mixed with the feed mixture. For example, during separation of water from oil, such as lubricating oil and fuel oil, emulsions between water and oil may be formed in the separator bowl upon traditional recirculation of the heavy phase (water) to the inlet feed. Such emulsions are more difficult to separate in the centrifugal separator. However, with the centrifugal separator according to the first aspect of the invention, the liquid heavy phase may be recirculated without being mixed with the inlet feed before reaching the sludge space of the centrifuge rotor. Moreover, with the configuration of the conduit system, liquid heavy phase separation becomes more efficient since recirculating water does not have to be separated several times compared to prior art recirculation solutions.

In embodiments, the conduit system is arranged for recirculating separated liquid heavy phase to a radial inner position of the sludge space. “A radial inner position” may be within radial inner half of the sludge space. This is in contrast to pipes that may be used for washing open nozzles arranged at the periphery of the bowl. Thus, the conduit system may be arranged for recirculating the separated liquid heavy phase to the sludge space at a radial position that is at the radial outer edge of the distributor. The distributor may be used for holding the separation discs and for guiding the liquid feed mixture from the inlet to the separation space.

The centrifugal separator may comprise an inlet pipe extending into the centrifuge rotor for transporting the liquid feed mixture to the inlet. Further, this inlet pipe may be arranged coaxially with the rotational axis (X). In embodiments of the first aspect of the invention, the centrifugal separator is further comprising an inlet pipe arranged for introducing the liquid feed mixture to the inlet, and the conduit system comprises a recirculation inlet pipe arranged within the inlet pipe.

Thus, recirculation of separated heavy phase may be performed using a recirculation inlet pipe having a smaller outer diameter compared to the inner diameter of the inlet pipe for the feed mixture. The inlet pipe may be a stationary inlet pipe. Further, the recirculation inlet pipe may be a stationary pipe. The inlet pie and the recirculation inlet pipe may be concentric pipes around rotational axis (X).

As an example, the inlet pipe may extend into the centrifuge rotor axially from the top. Thus, also the recirculation inlet pipe may extend into the centrifuge rotor axially from the top.

In embodiments of the first aspect of the invention, the stack of separation discs is arranged axially on top of a distributor and the conduit system comprises at least one channel arranged axially below the distributor for guiding the recirculated liquid heavy phase radially outwards to the sludge space.

Thus, the stack of separation discs may be supported by the distributor. The inlet pipe may extend axially from the top through the distributor to the inlet.

The distributor is arranged for guiding the liquid feed mixture from the inlet to the separation space. Therefore, the distributor may comprise or form a set of channels for guiding the liquid feed mixture. These channels may be arranged for guiding the liquid feed radially outwards.

The channels axially below the distributor may comprise different portions, such as ditches, recesses, channels or guiding means on portions of the centrifuge rotor.

The at least one channel arranged axially below the distributor for guiding the recirculated liquid heavy phase to the sludge space may be arranged for guiding the recirculated liquid heavy phase radially outwards. The at least one channel may thus have a radially outer outlet arranged so that the recirculated heavy phase is transported to the sludge space under the distributor and then released to the sludge space at a radial position that is at the outer edge of the distributor.

Thus, the recirculated heavy phase may thus be introduced to the sludge space at a radial position that is larger than the radial position at which the liquid feed is introduced into the stack of separation discs.

The disc stack may further be compressed axially between a top disc and the distributor. The top disc may have an outer radius that is larger than the separation discs of the disc stack in order to guide separated heavy phase out of the separator space axially above the top disc. A top disc may further have a larger thickness as compared to the separation discs of the disc stack. In embodiments, the top disc is integrated with the wall of the centrifuge rotor. Thus, the top disc may be formed by e.g. the inner wall of the upper part of the centrifuge rotor.

Furthermore, the recirculation inlet pipe may extend to the at least one channel arranged axially below the distributor. Thus, the recirculation inlet pipe may extend through the whole distributor and may thus have an end portion at the proximity of the channels below the distributor for delivery of the recirculated liquid heavy phase to these channels.

In embodiments of the first aspect of the invention, the centrifugal separator further comprises a throttle valve arranged for throttling the separated liquid heavy phase, wherein the throttle valve is arranged upstream of the first outlet for the heavy phase.

The throttle valve may be for restricting the flow of separated liquid heavy phase to the first liquid outlet and may have an opening dimensioned for the intended liquid mixture to be separated. The throttle valve may be arranged at a radius that is larger than the radial position of the first liquid outlet, i.e. the liquid heavy phase outlet.

Separated liquid heavy phase may be guided axially above the top disc to a channel delimited by the upper inner wall of the centrifuge rotor. The throttle valve may be arranged in such a channel.

In embodiments of the first aspect of the invention, the conduit system further comprises a recirculation inlet and a conduit connecting the first outlet for the liquid heavy phase with the recirculation inlet.

The recirculation inlet may be arranged in the frame of the centrifugal separator. For example, the recirculation inlet may be connected to a recirculation inlet pipe as discussed above for introducing recirculated liquid heavy phase to the recirculation inlet pipe.

As an example, the conduit connecting the first outlet for the liquid heavy phase with the recirculation inlet comprises a valve means arranged for determining the amount of separated liquid heavy phase being recirculated to the recirculation inlet.

The valve means may be a check valve for completely closing the recirculation in the conduit system. Thus, during operation, liquid heavy phase may be accumulated in the centrifuge rotor until the check valve is opened. The valve means thus allows for controlling when recirculation of liquid heavy phase should occur.

As a configuration of the first aspect, there is provided a centrifugal separator for separating a liquid heavy phase and a liquid light phase from a liquid feed mixture, comprising
a frame, a drive member and a rotating part,
wherein the drive member is configured to rotate the rotating part in relation to the frame around an axis of rotation (X), and
wherein the rotating part comprises a centrifuge rotor enclosing a separation space and a sludge space;
wherein the separation space comprises a stack of separation discs arranged coaxially around the axis of rotation (X) and wherein the sludge space is arranged radially outside the stack of separation discs;
wherein the centrifugal separator further comprises an inlet for receiving the liquid feed mixture into the centrifuge rotor, a first outlet for the liquid heavy phase and a second outlet or the liquid light phase, and
wherein the centrifugal separator further comprises a conduit system for recirculating separated liquid heavy phase discharged from the first outlet to the sludge space within the centrifuge rotor of the centrifugal separator without mixing the recirculated separated liquid heavy phase with the liquid feed mixture.

Embodiments discussed in relation to the first aspect above are compatible with this configuration of the first aspect.

As a second aspect of the invention, there is provided a centrifugal separator for separating a liquid heavy phase and a liquid light phase from a liquid feed mixture, comprising
a frame, a drive member and a rotating part,
wherein the drive member is configured to rotate the rotating part in relation to the frame around an axis of rotation (X), and
wherein the rotating part comprises a centrifuge rotor enclosing a separation space and a sludge space;
wherein the separation space comprises a stack of separation discs arranged coaxially around the axis of rotation (X) and wherein the sludge space is arranged radially outside the stack of separation discs;
wherein the centrifugal separator further comprises an inlet for receiving the liquid feed mixture into the centrifuge rotor, a first outlet for the liquid heavy phase and a second outlet for the liquid light phase,
wherein the centrifugal separator is further comprising a stationary inlet pipe arranged for introducing the liquid feed mixture to the inlet, and a conduit system for introducing a liquid to a radial inner position of the sludge space of the centrifugal separator, wherein the conduit system comprises a stationary recirculation inlet pipe arranged within the inlet pipe.

The radial inner position of the sludge space may be at the radial inner half of the sludge space, such as at the radially outer edge of the distributor. Further, the centrifugal separator may sludge outlets, other than the first and second outlets, for discharge of sludge separated from the liquid feed mixture. The sludge outlets may be for intermittent discharge of sludge.

This aspect may generally present the same or corresponding advantages as the former aspect. Effects and features of this second aspect are largely analogous to those described above in connection with the first and second aspects. Embodiments mentioned in relation to the first aspects are largely compatible with the second aspect

As a third aspect of the invention, there is provided a method of separating a liquid heavy phase and a liquid light phase from a liquid feed mixture, comprising the steps of
a) introducing the liquid feed mixture into a centrifugal separator according to the first aspect of the invention;
b) discharging a separated liquid light phase from the centrifugal separator,
c) discharging a separated liquid heavy phase from the centrifugal separator
d) recirculating at least a portion of the discharged separated liquid heavy phase to the sludge space without mixing the recirculated separated liquid heavy phase with the liquid feed mixture, and
e) ejecting a separated solid phase through a set of radially outlets arranged at the outer periphery of the centrifuge rotor.

This aspect may generally present the same or corresponding advantages as the former aspects. Effects and features of this third aspect are largely analogous to those described above in connection with the first and second aspects. Embodiments mentioned in relation to the first and second aspect are largely compatible with the third aspect.

Step d) may comprise recirculating separated liquid heavy phase to a radial inner position of the sludge space. A radial inner position may thus be the radial inner half of the sludge space.

In embodiments of the third aspect, the centrifugal separator comprises an inlet pipe arranged for introducing the liquid feed mixture to the inlet, and wherein the recirculation is performed via a recirculation inlet pipe arranged within the inlet pipe.

As discussed above, the inlet pipe for the liquid feed mixture provides a suitable position for a recirculation inlet pipe when introducing the recirculated liquid heavy phase.

As an example, the inlet pipe may extend into the centrifuge rotor axially from the top.

In embodiments of the third aspect of the invention, the stack of separation discs are arranged axially on top of a distributor, and wherein the recirculation comprises guiding the recirculated liquid heavy phase radially outwards under the distributor.

Consequently, the recirculation may be performed via a pipe extending in the inlet pipe from the top of the centrifugal separator down to under the distributor, from where the recirculated liquid heavy phase is guided radially outwards.

As an example, the step d) may comprise guiding the separated liquid heavy phase to the sludge space at a radial position that is at the radial outer edge of the distributor.

Thus, the method may comprise introducing recirculated liquid heavy phase top the radially innermost position of the sludge space that is located radially outside of the disc stack

In embodiments of the third aspect, the step e) comprises intermittently ejecting a separated solid phase through a set of radially outlets arranged at the outer periphery of the centrifuge rotor.

During intermittent discharge, sludge, i.e. a solid phase, that has accumulated at the periphery of the centrifuge rotor may be ejected to a space under the frame outside of the centrifuge rotor, as known in the art. The sludge may also comprise some liquid. Further, also some liquid heavy phase being present in the centrifuge rotor may be ejected during the intermittent discharge.

The method may further comprise a step of stopping the recirculation flow during separation of the liquid feed mixture that is introduced to the centrifugal separator.

As an example, step e) may further comprise introducing displacement liquid to the centrifuge rotor via the conduit system for recirculating separated liquid heavy phase before ejecting the separated solid phase.

Hence, the conduit system for recirculating liquid heavy phase may also be used for introducing displacement liquid before ejection of solids. As known in the art, so-called displacement liquid, such as water, is normally supplied to the centrifuge rotor just before each opening of the sludge outlets. The purpose of a supply of displacement liquid to decrease the amount of separated light liquid in the separation space so that no such light liquid leaves the separation space through the sludge outlet when it is opened. If the heavier of the liquids to be separated is water, water is normally used as the displacement liquid.

Also introducing displacement liquid via the conduit system, such as the recirculation inlet pipe, is advantageous in that it prevents the formation of emulsions within the centrifuge rotor.

Moreover, the recirculation flow may be stopped during step e) of intermittent discharge of solids.

In embodiments of the third aspect, the method is comprising only performing steps a) and b) during a first time interval and performing all of steps a) to d) during a second time interval.

Moreover, step c) of discharging a separated liquid heavy phase may be performed with varied outlet flow of separated liquid heavy phase. Thus, step c) may be performed by first allowing only no or a first flow of separated liquid heavy phase being discharged during a first time period, and then allowing a second flow, larger than the first flow, of separated liquid heavy phase being discharged during a second time period.

Consequently, during operation, the liquid feed mixture may be separated into a liquid heavy phase and a liquid light phase. The liquid light phase may continuously be discharged from the second outlet of the separator, whereas discharge of the separated liquid heavy phase via the first liquid outlet may be performed when enough liquid heavy phase has been separated out from the liquid feed mixture within the centrifuge rotor, i.e. during discrete time periods.

In embodiments of the third aspect, liquid feed mixture is an oily mixture and the liquid heavy phase is an aqueous phase, such as water.

The oily mixture may be fuel oil or lubricating oil. The method of the third aspect may be performed onboard a ship.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of a centrifugal separator according to an embodiment of the present invention.

FIG. 2 shows a schematic drawing of a cross-section of a centrifuge rotor.

FIG. 3 shows a flow chart of a method according to the present disclosure.

### DETAILED DESCRIPTION

The centrifugal separator and the method according to the present disclosure will be further illustrated by the following description with reference to the accompanying drawings.

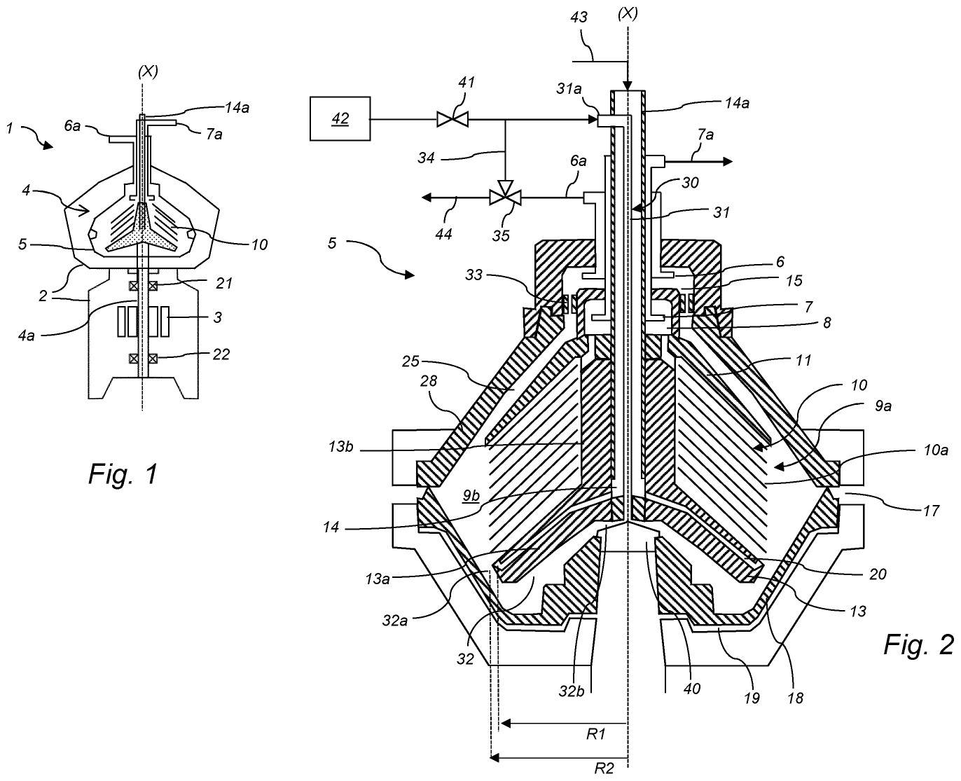

FIG. 1 show a cross-section of an embodiment of a centrifugal separator 1 configured to separate a heavy phase and a light phase from a liquid feed mixture. The centrifugal separator 1 has a rotating part 4, comprising the centrifuge rotor 5 and drive spindle 4a.

The centrifugal separator 1 is further provided with a drive motor 3. This motor 3 may for example comprise a stationary element and a rotatable element, which rotatable element surrounds and is connected to the spindle 4a such that it transmits driving torque to the spindle 4a and hence to the centrifuge rotor 5 during operation. The drive motor 3 may be an electric motor. Alternatively, the drive motor 3 may be connected to the spindle 4a by transmission means. The transmission means may be in the form of a worm gear which comprises a pinion and an element connected to the spindle 4a in order to receive driving torque. The transmission means may alternatively take the form of a propeller shaft, drive belts or the like, and the drive motor may alternatively be connected directly to the spindle 4a.

The centrifuge rotor 5, shown in more detail in FIG. 2, is supported by the spindle 4a, which is rotatably arranged in a frame 2 around the vertical axis of rotation (X) in a bottom bearing 22 and a top bearing 21. The stationary frame 2 surrounds centrifuge rotor 5.

Also shown in FIG. 1 is an inlet pipe 14a extending into the centrifuge rotor 5 axially from the top. After separation has taken place within the centrifuge rotor 5, separated liquid heavy phase is discharged thorough stationary outlet pipe 6a, whereas separated liquid light phase is discharged through stationary outlet pipe 7a.

FIG. 2. shows a more detailed view of the centrifuge rotor 5 of the centrifugal separator 1.

The centrifuge rotor 5 forms within itself a separation space 9a and a sludge space 9b, located radially outside the separation space 9a. In the separation space 9a, a stack 10 of separation discs 10a is arranged coaxially around the axis of rotation (X) and axially below a top disc 11 and is thus arranged to rotate together with the centrifuge rotor 5. The separation discs 10a provide for an efficient separation of the liquid mixture into at least a liquid light phase and a liquid heavy phase. Thus, in the separation space 9a centrifugal separation of e.g. a liquid feed mixture to takes place during operation.

The stack 10 is supported at its axially lowermost portion by distributor 13. The distributor 13 comprises an annular conical base portion 13a arranged to conduct liquid from the center of the centrifuge rotor 5 to a predetermined radial level in the separation space 9, and a central neck portion 13b extending upwards from the base portion 13a.

The sludge space 9b is in this embodiment confined between the upper part 28 of the centrifuge rotor 5 and an axially movable operating slide 18.

The centrifugal separator 1 further comprises an inlet 14 in the form of a central inlet chamber formed within or under the distributor 13 into which a stationary inlet pipe 14a extends for supply of the liquid feed mixture to be separated. The inlet 14 communicates with the separation space 9 via passages 20 formed in the base portion 13a of the distributor 13. The passages may be arranged so that liquid mixture is transported to a radial level R1, which may correspond to the radial level of the outer portion of the stack of separation discs. For example, the radial level R1 may be at the radial level of a plurality of cut-outs provided in the separation discs the cut-outs may for example be in the form of slits provided at a radially outer portion of the separation disc 10a, which slits are open towards the outer radius of the separation disc 10a. Such slits may for example be provided in the separation discs when the liquid feed mixture is an oil.

The top disc 11 and an upper inner wall part 28 of the centrifuge rotor 5 delimits at least one channel 25 extending from the radially inner portion of the sludge space 9b towards a central portion of the centrifuge rotor 5. The first liquid outlet 6 is arranged in a first outlet chamber 15, which is in fluid communication with the at least one channel 25 for discharge of a separated liquid heavy phase. The first liquid outlet 6 is in the form of a stationary paring disc arranged in the outlet chamber 15 for the separated heavy phase for discharging the heavy phase into outlet pipe 6a.

The radially inner portion of the disc stack 10 communicates with a second outlet 7 for a separated light phase of the liquid feed mixture. The second outlet 7 is arranged in a second outlet chamber 8. The second outlet 7 is in the form of a stationary paring disc for discharge of the light phase into outlet pipe 7a. The paring disc 12 is supported in the second outlet chamber 8 by the stationary inlet pipe 14a

The centrifuge rotor 5 is further provided with outlets 17 at the radially outer periphery of the sludge space 9b. These outlets 17 are evenly distributed around the rotor axis (X) and are arranged for intermittent discharge of a sludge component of the liquid feed mixture. The sludge component comprises denser particles forming a sludge phase. The opening of the outlets 17 is controlled by means of an operating slide 18 actuated by operating water in channel 19, as known in the art. In its position shown in the drawing, the operating slide 18 abuts sealingly at its periphery against the upper part 28 of the centrifuge rotor 5, thereby closing the sludge space 9b from connection with outlets 17, which are extending through the centrifuge rotor 5.

However, the centrifugal separator 1 could also be a solid wall bowl centrifuge, i.e. a centrifuge lacking outlets at the periphery of the centrifuge rotor 5.

As seen in FIG. 2, the centrifugal separator 1 also comprises a conduit system 30 for recirculating separated liquid heavy phase to the sludge space 9b within the centrifuge rotor 5 without mixing the recirculated separated liquid heavy phase with the liquid feed mixture. This is achieved by stationary recirculation inlet pipe 31 that is arranged within the stationary inlet pipe 14a for the liquid feed mixture. The recirculation inlet pipe 31 is at the top of the separator connected to a recirculation inlet 31a, and then extends concentrically with rotational axis X down from the top through the inlet pipe 14a and inlet 14 to a position axially under the distributor 13. The dimension of the recirculation inlet pipe may be selected based on the required recirculation flow rate. As an example, the conduit system 30 may be arranged for recirculating liquid heavy phase with a flow rate that is below 20 m/s in the recirculation inlet pipe 14a.

The recirculation inlet 31a is connected with conduit 34 to the stationary outlet pipe 6a for the liquid heavy phase. This conduit also comprises regulating valve 35 for determining if liquid heavy phase released from the separator should be recirculated via conduit 34 to recirculation inlet 31a or released to drain via conduit 44. The regulating valve 35 may also be used to stop the discharge of separated liquid heavy phase completely.

Moreover, the recirculation inlet 31a is also connected to a source of liquid 42. This liquid may be displacement liquid that may be introduced to the centrifuge rotor 5 via the recirculation inlet before ejecting sludge via sludge outlets 17. Valve 41 may be used for controlling if displacement liquid should be introduced into the centrifuge rotor. The source of liquid 42 may for example be part of a water system onboard a ship.

Moreover, there are a throttle valve 33 arranged upstream of the first outlet 6 for the liquid heavy phase. This throttle valve 33 is arranged for throttling the liquid heavy phase that is being discharged via the first outlet 6. The dimensions of the throttle valve 33 may be selected based on the expected amount of heavy phase present in the liquid feed mixture to be separated.

The conduit system 30 further comprises at least one channel 32 arranged axially under the distributor 13 for guiding the recirculated liquid heavy phase to the sludge space 9b. These channels 32 under the distributor 13 comprises in this embodiment a radial inner portion 32b that is formed as channels in the cone 40 that secures the centrifuge rotor 5 to the spindle 4a. The channels under the distributor 13 further comprises a radial outer portion 32a arranged for guiding the recirculated heavy phase into the sludge space just under the radial outer brim or portion of the distributor, in this case just under the radial edge of the base portion 13a of the distributor. Thus, the at least one channel 32 under the distributor 13 are arranged for guiding or releasing the recirculated liquid heavy phase to the sludge space at a radial position R2 that is larger than the radial position R1 as discussed above.

During operation of the separator as shown in FIGS. 1 and 2, the centrifuge rotor 5 is brought into rotation by the drive motor 3. Via the inlet pipe 14a, liquid feed mixture to be separated is brought into the separation space 9a. Depending on the density, different phases in the liquid feed mixture is separated between the separation discs 10a of the stack 10. Heavier component, such as a water phase and a sludge phase, move radially outwards between the separation discs 10a to the sludge space 9b, whereas the phase of lowest density, such as an oil phase, moves radially inwards between the separation discs 10a and is forced through second outlet 7 arranged in the second liquid outlet chamber 8. The liquid of higher density is instead forced out through the passages 25 over the top disc to the liquid outlet 6 for the heavy phase that is arranged at a radial distance that is larger than the radial level of the outlet 7 for the light phase. The throttling valve 33 is used to determine the flow of separated liquid heavy phase to the first outlet 6. However, the valve 35 at downstream of the first liquid outlet 6 may be closed until enough liquid heavy phase has been separated out from the liquid feed mixture. Opening of the valve 35 thus allows for discharge of the liquid heavy phase via the first liquid outlet 6.

Thus, during separation, an interphase between the liquid of lower density and the liquid of higher density is formed in the centrifuge rotor 5, such as radially within the stack of separation discs. Solids, or sludge, accumulate at the periphery of the sludge space 9b, in the sludge space, and is emptied intermittently from within the centrifuge rotor by the sludge outlets 17 being opened, whereupon sludge and a certain amount of fluid is discharged from the separation chamber 17 by means of centrifugal force. However, the discharge of sludge may also take place continuously, in which case the sludge outlets 17 take the form of open nozzles and a certain flow of sludge and/or heavy phase is discharged continuously by means of centrifugal force.

Discharged liquid heavy phase is recirculated via recirculation inlet pipe 31a and passages 32 arranged axially below the distributor back to the sludge space. In this way, recirculated heavy phase, such as water is prevented from being mixed with the liquid feed mixture at the inlet, such as an oil.

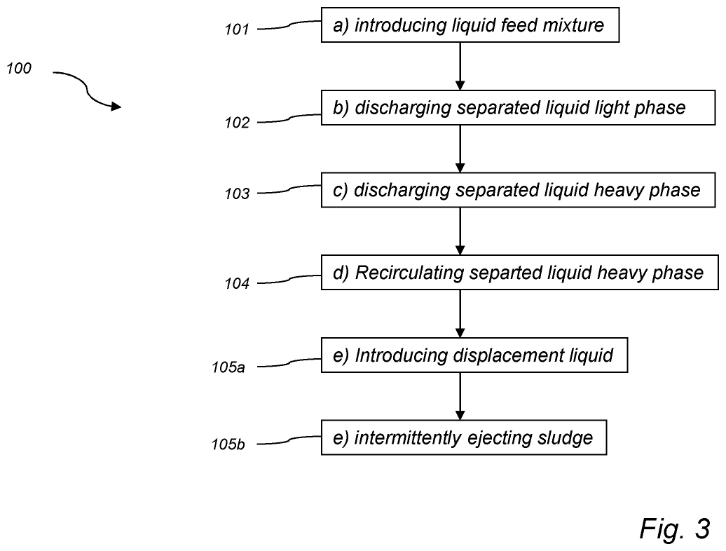

FIG. 3 illustrates a method 100 of separating a liquid heavy phase and a liquid light phase from a liquid feed mixture. The method 100 comprises the steps of
a) introducing 101 the liquid feed mixture into a centrifugal separator 1.
b) discharging 102 a separated liquid light phase from the centrifugal separator 1,
c) discharging 103 a separated liquid heavy phase from the centrifugal separator 1, and
d) recirculating 104 at least a portion of the discharged separated liquid heavy phase to the sludge space 9b without mixing the recirculated separated liquid heavy phase with the liquid feed mixture.

The centrifugal separator may be as discussed in relation to FIGS. 1 and 2 above.

The method is preferably used when the centrifugal separator 1 comprises an inlet pipe 14a arranged for introducing the liquid feed mixture to the inlet 14 and wherein the recirculation is performed via a recirculation inlet pipe 31 arranged within the inlet pipe 14a. As discussed above, the stack 10 of separation discs 10a may be arranged axially on top of a distributor 13, and the recirculation of step d) may comprise guiding the recirculated liquid heavy phase radially outwards under the distributor 13.

Moreover, step d) may comprise guiding the separated liquid heavy phase to the sludge space 9b at a radial position that is at the radial outer edge of the distributor 13. Thus, step d) may comprise releasing the recirculated liquid heavy phase to the sludge space at a radial inner portion of the sludge space.

The method may further comprise a step e) of intermittently ejecting 105b a separated solid phase through a set of radially outlets 17 arranged at the outer periphery of the centrifuge rotor 5. This step e) may further comprise introducing displacement liquid 105a to the centrifuge rotor before ejecting the separated solid phase. This displacement liquid may be supplied e.g. via the conduit system 3 for recirculating separated liquid heavy phase.

The liquid feed mixture may be an oily mixture and the liquid heavy phase may an aqueous phase, such as water. Consequently, the method may be used for cleaning fuel oil or lubrication oil, e.g. onboard a ship. During such a cleaning of oil in a separator as shown in FIGS. 1 and 2, oil feed is supplied continuously through the inlet pipe 14. After the separating operation has been going on for a period of time, cleaned oil will continuously leave the centrifuge rotor 5 through the second liquid outlet 7. During this period of time an amount of solids and an amount of water is separated from the oil flowing through the stack 10 of separation discs 10a and an interface layer between oil and water may be formed at a certain radial level within the stack. Any water being discharged via the first liquid outlet 6 is recycled back to the sludge space 9b. Before ejecting a sludge phase, i.e. separated solids, recirculation is stopped, e.g. by guiding discharged water to drain via conduit 44, and displacement water is instead introduced via the conduit system 30 to force oil out of the centrifuge rotor to prevent loss of oil during subsequent intermittent discharge. The opening time of sludge outlets 17 is sufficiently long so that all separated solids and displacement water are thrown out of the centrifuge rotor, but sufficiently short to prevent loss of oil. After an intermittent discharge, a new separation period is started, and oil feed is again supplied to the separator 1.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A centrifugal separator for separating a liquid heavy phase and a liquid light phase from a liquid feed mixture, comprising:
a frame;
a drive member; and
a rotating part,
wherein the drive member is configured to rotate the rotating part in relation to the frame around an axis of rotation,
wherein the rotating part comprises a centrifuge rotor enclosing a separation space and a sludge space,
wherein the separation space comprises a stack of separation discs arranged coaxially around the axis of rotation and wherein said sludge space is arranged radially outside said stack of separation discs,
wherein the centrifugal separator further comprises an inlet for receiving the liquid feed mixture into the centrifuge rotor, a first outlet for the liquid heavy phase and a second outlet for the liquid light phase,
wherein the centrifugal separator further comprises a conduit system for recirculating separated liquid heavy phase discharged from the first outlet to the sludge space within the centrifuge rotor of the centrifugal separator without mixing the recirculated separated liquid heavy phase with the liquid feed mixture, and
wherein said centrifugal separator further comprises sludge outlets, other than the first and second outlets, for discharge of sludge separated from said liquid feed mixture.

2. The centrifugal separator according to claim 1, wherein the conduit system is arranged for recirculating separated liquid heavy phase to a radial inner position of the sludge space.

3. The centrifugal separator according to claim 1, further comprising an inlet pipe arranged for introducing said liquid feed mixture to said inlet, and wherein said conduit system comprises a recirculation inlet pipe arranged within said inlet pipe.

4. The centrifugal separator according to claim 1, wherein the sludge outlets are arranged for intermittent discharge of sludge separated from said liquid feed mixture.

5. The centrifugal separator according to claim 1, wherein said stack of separation discs is arranged axially on top of a distributor, and wherein said conduit system comprises at least one channel arranged axially below said distributor for guiding the recirculated liquid heavy phase radially outwards to said sludge space.

6. The centrifugal separator according to claim 5, further comprising an inlet pipe arranged for introducing said liquid feed mixture to said inlet, wherein said conduit system comprises a recirculation inlet pipe arranged within said inlet pipe, and wherein said recirculation inlet pipe extends to said at least one channel arranged axially below the distributor.

7. The centrifugal separator according to claim 1, wherein the centrifugal separator further comprises a throttle valve arranged for throttling the separated liquid heavy phase, wherein said throttle valve is arranged upstream of the first outlet for the heavy phase.

8. The centrifugal separator according to claim 1, wherein the conduit system further comprises a recirculation inlet and a conduit connecting the first outlet for the liquid heavy phase with said recirculation inlet.

9. The centrifugal separator according to claim 8, wherein said conduit connecting the first outlet for the liquid heavy phase with said recirculation inlet comprises a valve arranged for determining the amount of separated liquid heavy phase being recirculated to said recirculation inlet.

10. A method of separating a liquid heavy phase and a liquid light phase from a liquid feed mixture, comprising the steps of:
a) introducing the liquid feed mixture into the centrifugal separator according to claim 1;
b) discharging a separated liquid light phase from said centrifugal separator;
c) discharging a separated liquid heavy phase from said centrifugal separator;
d) recirculating at least a portion of the discharged separated liquid heavy phase to the sludge space without mixing the recirculated separated liquid heavy phase with the liquid feed mixture; and
e) ejecting a separated solid phase through a set of radial outlets arranged at an outer periphery of the centrifuge rotor.

11. The method according to claim 10, wherein the centrifugal separator comprises an inlet pipe arranged for introducing said liquid feed mixture to said inlet, and wherein said recirculation is performed via a recirculation inlet pipe arranged within said inlet pipe.

12. The method according to claim 10, wherein said stack of separation discs is arranged axially on top of a distributor, and wherein said recirculation comprises guiding the recirculated liquid heavy phase radially outwards under said distributor.

13. The method according to claim 12, wherein step d) comprises guiding the separated liquid heavy phase to the sludge space at a radial position that is at a radial outer edge of the distributor.

14. The method according to claim 10, wherein step e) comprises intermittently ejecting a separated solid phase through a set of radial outlets arranged at the outer periphery of the centrifuge rotor.

15. The method according to claim 14, wherein step e) further comprises introducing displacement liquid to the centrifuge rotor via the conduit system for recirculating separated liquid heavy phase before ejecting said separated solid phase.

16. The method according to claim 10, wherein the liquid feed mixture is an oily mixture and the liquid heavy phase is an aqueous phase.

17. The method according to claim 10, wherein step d) comprises recirculating separated liquid heavy phase to a radial inner position of the sludge space.

18. The centrifugal separator according to claim 2, further comprising an inlet pipe arranged for introducing said liquid feed mixture to said inlet, and wherein said conduit system comprises a recirculation inlet pipe arranged within said inlet pipe.

19. The centrifugal separator according to claim 2, wherein the sludge outlets are arranged for intermittent discharge of sludge separated from said liquid feed mixture.

20. The centrifugal separator according to claim 3, wherein the sludge outlets are arranged for intermittent discharge of sludge separated from said liquid feed mixture.
